(19) United States
(12) Patent Application Publication
(10) Pub. No.: US 2011/0202845 A1
(43) Pub. Date: Aug. 18, 2011

(54) SYSTEM AND METHOD FOR GENERATING AND DISTRIBUTING THREE DIMENSIONAL INTERACTIVE CONTENT

(76) Inventor: Anthony Jon Mountjoy, Craik (CA)

(21) Appl. No.: 13/029,507

(22) Filed: Feb. 17, 2011

Related U.S. Application Data
(60) Provisional application No. 61/305,421, filed on Feb. 17, 2010.

(51) Int. Cl. G06F 3/00

(52) U.S. Cl. 715/733

(57) ABSTRACT

A system and method for generating three dimensional images is provided. The system can include interface devices and display devices associated with each interface device. Servers operative to generate a series of three dimensional images and transmit the generated three dimensional images to the display device. If the servers receive user input from the one of the interface devices, the servers can alter the series of three dimensional images being generated and transmit the altered three dimensional images to the display device associated with the interface device.

### CROSS-REFERENCE TO RELATED APPLICATIONS

This application claims the benefit of Provisional Application No. 61/305,421, filed Feb. 17, 2010, which is currently pending.

### BACKGROUND OF THE INVENTION

The present invention relates to a system to generate and display interactive three dimensional image content.

Televisions and/or computer monitors are sometimes used to display three dimensional images. Three dimensional images can be created in a variety of ways, many of which include the use of two different images of a scene to give the appearance of depth. For polarization three-dimensional systems, two images are superimposed and polarized filters (e.g. polarized glasses) are used to view the three-dimensional images created by these superimposed images. In eclipse methods for producing three dimensional images two images are alternated and mechanical or other blinder mechanisms open and close the various eyes in synchronization with the screen.

Three dimensional images can be relatively easily obtained on televisions and personal computers for prerecorded content. For example, movies, television shows and other pre-recorded visual content can be displayed on current televisions and computer monitors with relative ease. However, to create a three dimensional image of interactive content in near real-time (e.g. a video game, computer interface, etc.) is a much harder task to achieve. This is because the three dimensional images have to be rendered in substantially real-time and have to be varied and altered in response to a user's inputs. For example, if a user moves a character in a video game to the right instead of the left, the system could not predict in which direction the user would move the character and would have to create new images based on the user's unforeseen inputs.

All of this rendering of the three dimensional images on the screen takes an immense amount of processing power.

### SUMMARY OF THE INVENTION

In a first aspect, a system for generating three dimensional images is provided. The system comprises: a plurality of interface devices, each interface device having an input, the interface device operative to receive input data from a user; a display device associated with each interface device and operative to display three dimensional images; at least one server operative to: for each display device, generate a series of three dimensional images and transmit the generated three dimensional images to the display device; and receive input data from each of the plurality of interface devices; and at least one network connection operatively connecting the at least one server to each interface device and each display device. The at least one server, in response to receiving input data from one of the interface devices, is operative to alter the series of three dimensional images being generated by the at least one server for the display device associated with the interface device, based on the input data, and transmit the altered three dimensional images to the display device associated with the interface device

In a another aspect, a method for generating three dimensional images is provided. The method comprises: having at least one server generate a series of three dimensional images and transmit the series of three dimensional images to a display device; and in response to the at least one server receiving input data from an interface device associated with the display device, altering the series of three dimensional images being generated and transmitting the altered three dimensional images to the display device.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is schematic illustration of a system diagram for generating and displaying interactive three dimensional images;

FIG. 2 is a schematic illustration of a server cluster used in the system shown in FIG. 1;

FIG. 3A is a schematic illustration of an alternate system for generating and displaying interactive three dimensional images;

FIG. 3B is a schematic illustration of another alternate system for generating and displaying interactive three dimensional images;

FIG. 4 is an architecture illustration of the server cluster;

FIG. 5 is a flowchart of a method for initializing a session between the interface device and a server cluster;

FIG. 6 is a sequence diagram illustrating the interaction between the server cluster, the interface device and the display device after generating a three dimensional image;

FIG. 7 is a flowchart of a method of a cell processor of a sub-node rendering pixels in a three dimensional image;

FIG. 8 is a flowchart of a method of a head node of the server cluster compiling a three dimensional image for transmission to the interface device;

FIG. 9 is a sequence diagram showing the interactions between the interface device and the server cluster when user input is received by the system; and

FIG. 10 is a flowchart of a method for altering the three dimensional image being generated in response to user input.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

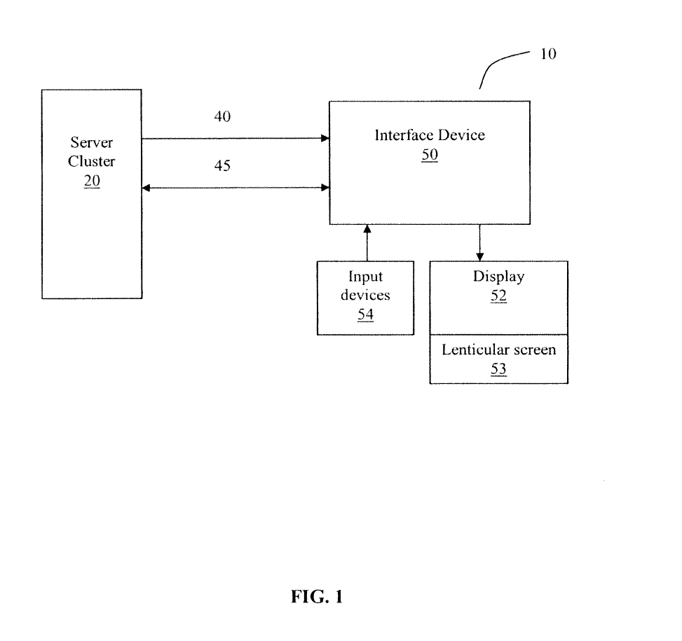

FIG. 1 illustrates a system diagram of a system 10 having a server cluster 20 connected to a number of interface devices 50. Each interface device 50 can be connected to a display device 52, for displaying three dimensional images, and a number of input devices 54. In the system 10, three dimensional images are generated by the server cluster 20 and then transmitted to the interface device 50 for display on the connected display device 52. The input devices 54 allow a user to provide input to the interface device 50, which is then transmitted to the server cluster 20 and used to alter the three dimensional images being generated.

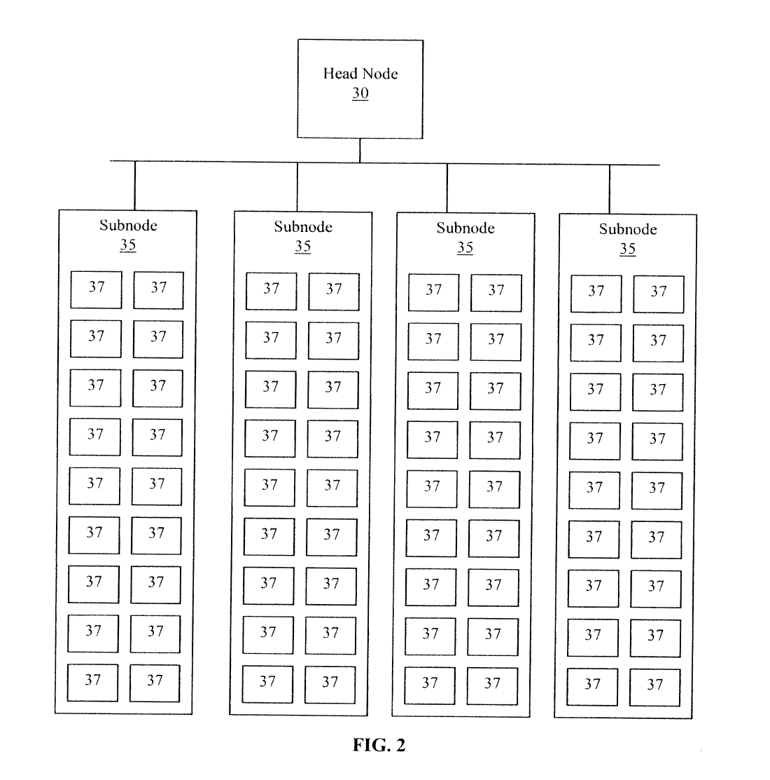

The server cluster 20 can be a number of server computers linked together to operate in conjunction. The server cluster 20 can be responsible for doing the majority of the processing such as generating three dimensional images in substantially real time to be displayed by the interface devices 50 on the various display devices 52. The server cluster 20 can also generate audio data to be transmitted to the display device 52 to be played in conjunction with the generated images. FIG. 2 illustrates the server cluster 20 in one aspect, where a head node 30 is used to receive and transmit information into and out of the server cluster 20 and pass information to a number of other subnodes 35 in the server cluster 20. Each subnode 35 can have a plurality of processors 37 for the processing of data.

Referring again to FIG. 1, the server cluster 20 can be operatively connected to the interface devices 50 by a first network connection 40. The first network connection 40 is a one-direction high capacity network connection such as a satellite connection, such as a cable connection, HD television connect, etc. that allows the server cluster 20 to communicate data to the various interface devices 50. In one aspect, the high capacity network will have a capacity of one (1) gigabit or greater. The server cluster 20 can broadcast the same data to all or a number of the interface devices 50 simultaneously or it can transmit unique data to only a single interface device 50.

In addition to the first network connection 40, a second network connection 45 operably connects the server cluster 20 and the interface devices 50. Unlike the first network connection 40 which is a high capacity one-direction connection, the second network connection 45 can be lower capacity network, such as a broadband connection, other internet connection, etc. that allows two-way communication between the server cluster 20 and the interface device 50. The second network connection 45 does not have as much capacity as the first network connection 40. In one aspect, the capacity of the second network connection 45 could be less than one (1) gigabit. In a further aspect, the capacity of the second network connection 45 could be around ten (10) megabits.

The interface device 50 can be a data processing device operative to receive transmitted data from the server cluster 20 over both the first network 40 and the second network 45. The interface device 50 can also be configured to transmit data over the second network 45 to the server cluster 20.

In one aspect, the interface device 50 can be a general purpose computer using installed software to receive and process data from the server cluster 20 and display images received from the server cluster 20 on the display device 52. Alternatively, the interface devices 50 could be a specially prepared data processing system that is meant to only run the software for the system 10 and operate any connected devices. In this aspect, the interface device 50 may not provide many functions beyond formatting of the three dimensional images for display on the display device 52 and communicating to and from the server cluster 20.

The display device 52 is operatively connected to the interface device 50 so that the interface device 50 can display images received from the server cluster 20 on the display device 52. The display device 52 can be a television, HD television, monitor, handheld tablet, etc.

Typically, the three dimensional images displayed on the display device 52 are a composite left eye and right eye view image. In many cases, specially made glasses are used by a user to make the composite left eye and right eye image appear to be in three dimensions. However, in another aspect the display device 52 can be provided with a lenticular screen 53 so that the display device 52 can display three dimensional images on the display device 52 without a user requiring special glasses. The lenticular screen 53 can be applied at an approximate resolution. In another aspect, the lenticular screen 53 can be a digital lenticular screen that can accommodate multiple resolutions and holds the potential to create optimal viewing that considers user-specific vantage and display size.

The input devices 54 can be any suitable device to allow a user to interact with the interface device 50 such as a mouse, keyboard, rollerball, infrared sensor, camera, joystick, wheels, scientific instrument, scales, remote controlled devices such as robots, cameras, touch technology, gesture technology, etc. The input devices 54 can be operatively connected to the interface device 50 so that a user can use the input device 54 to provide input to the interface device 50. The input devices 54 can also be force feedback equipment, such as joysticks, steering wheels, etc. that can send signals to the input device 54 in response to a user's input or events occurring in the program. Force feedback data can be transmitted from the server cluster 20 to the interface device 50 and subsequently to any force feedback input devices 54.

In one aspect, the interface device 50 will be mainly used to receive three dimensional image data from the server cluster 20 over the first network 40 and do minimal formatting of the received images in order to display them on the display device 52 (e.g. decompressing and/or decrypting the image data, resolution and size adjustment, etc.). The interface device 50 can also be used to receive user input from one of the input devices 54 and transmit this user input to the server cluster 20 over the second network 45. In one aspect, audio data, that has been generated on the server cluster 20, can be transmitted to the interface devices 50 at the same time the three dimensional images are transmitted.

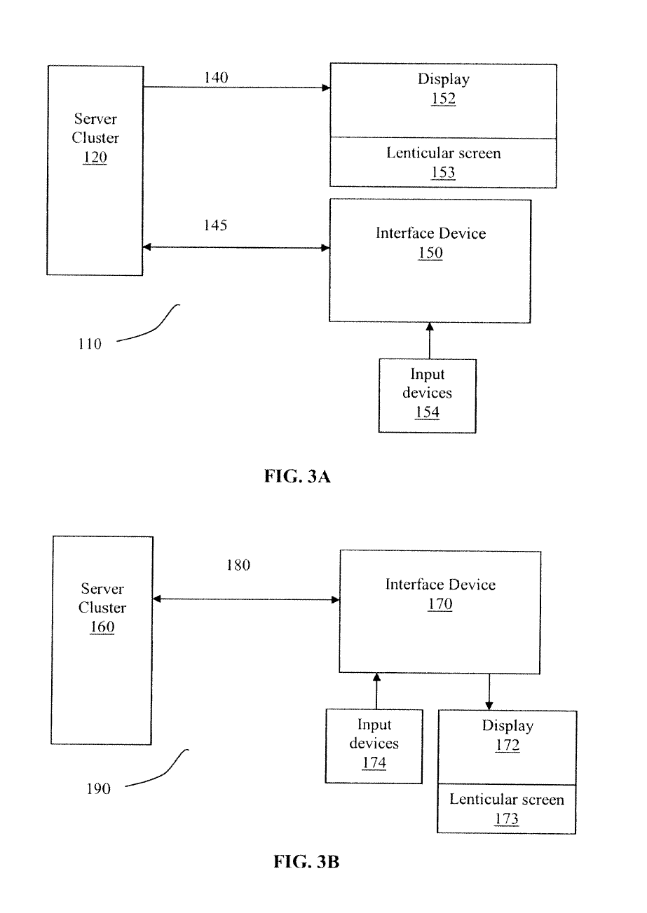

FIG. 3A illustrates a system diagram of a system 110, in another aspect, having a server cluster 120 connected to a number of interface devices 150 connected to input devices 154 and connected to display devices 152 for displaying three dimensional images. The server cluster 120, interface device 150, input devices 154, display device 152, and lenticular screen 153 can be similar to the server cluster 20, interface device 50, input device 54, display device 52, and lenticular screen 53 shown in FIG. 1. However, unlike system 10 in FIG. 1, system 110 uses a first network connection 140 to provide a high capacity one way connection between the server cluster 120 and the display device 152 (rather than the interface device 150) and the interface device 150 is connected to the server cluster 120 by a second network connection 145 similar to second network connection 45 shown in FIG. 1. Three dimensional images (and audio) can be transmitted directly from the server cluster 120 to the display device 152.

In this manner, interface device 150 can be used to receive inputs from a user using the input device 154 and transmit the input to the server cluster 120 where the server cluster 120 will alter the three dimensional images being generated as a result of the user input and transmit newly generated three dimensional images directly to the display device 152. This could be used where the display device 152 is a HD television connected to an HD cable connection and the server cluster 120 can transmit unique images over one of the channels.

FIG. 3B illustrates a system diagram of a system 190, in another aspect, having a server cluster 160 connected to a number of interface devices 170, which, in turn, are connected to input devices 174 and display devices 172 for displaying three dimensional images. The server cluster 160, interface device 170, input devices 174, display

device 172, and lenticular screen 173 can be similar to the server cluster 20, interface device 50, input device 54, display device 52, and lenticular screen 53 shown in FIG. 1. However, unlike system 10 in FIG. 1, system 190 uses a single network connection 180 to provide a high capacity two-way connection between the server cluster 160 and interface device 170. Three dimensional images (and audio) can be transmitted directly from the server cluster 160 to the interface device 170 for display on the display device 172 and the interface device 170 can use the network connection 180 to transmit data to the server cluster 160.

The server cluster 20 models a virtual three dimensional environment and describes this three dimensional environment by data. This three dimensional environment can be used to describe any sort of scene and/or collection of objects in the environment. The data description of the virtual three dimensional environment is then used by the server cluster 20 to generate three dimensional images that show views of this three dimensional environment and the objects contained within this three dimensional environment.

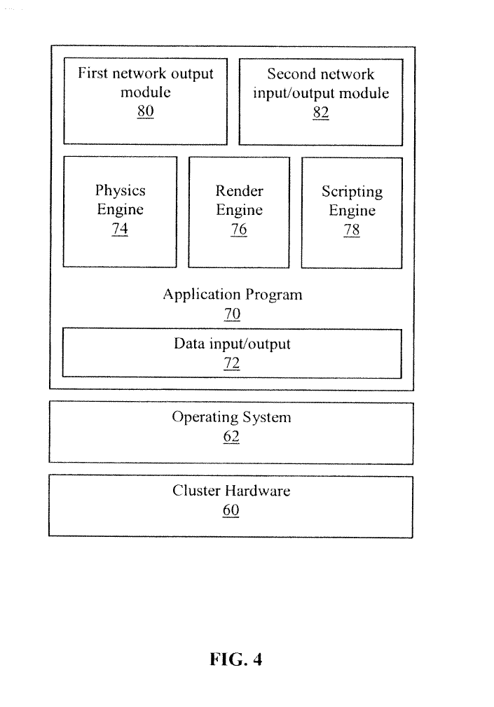

FIG. 4 is a schematic illustration of the server cluster 20. The server cluster 20 can have cluster hardware 60 including processors, memory, system buses, etc. An operating system 62 can be used to control the operation of the cluster hardware 60 and an application program 70 can be provided. A first network output module 80 can be provided to allow the server cluster 20 to be connected to the first network connection 40 and transmit data from the cluster server 20 over the first network connection 40. A second network input/output module 82 can be provided to allow the server cluster 20 to receive and transmit data to and from the second network connection 45.

The application program 70 can include a data input/output module 72 for controlling the passage of data between the application program 70 and the operating system 62 or the application program 70 and the cluster hardware 60. The application program 70 can also include a physics engine 74, a render engine 76 and a scripting engine 78. The scripting engine 78 can be used to control the operation of the application program 70. The physics engine 74 can be used to adjust the properties of objects in the virtual environment according to the properties of the objects and the inputs received from a user. The physics engine module 74 is used to determine collision detection as well as environmental effects such as mass, force, energy depletion, atmospheric events, liquid animations, particulates, simulated organic processions like growth and decay, other special effects that may not happen in nature, etc. The render engine module 76 creates the three dimensional images and does the necessary graphic processing, such as ray tracing to give light effects and give the image a photorealistic appearance.

The application program 70 also controls access to data based information, math processing, and makes sure the physics engine module 74 and the render engine module 76 have what they need to successfully achieve the application program 70 requirements.

Referring again to FIG. 1, in operation, the server cluster 20 generates three dimensional images that will eventually be displayed on a display device 52 connected to one of the interface devices 50. The server cluster 20 compresses the images and then transmits the images over the high capacity first network connection 40 to one or more of the interface devices 50. When the interface device 50 receives the transmitted image, it can decompress the image, apply any necessary formatting to the image to display it on the display device (e.g. decryption, resolution changes, size, etc.) and display the image on the display device 52 connected to the interface device 50. In order to display the three dimensional image, the interface device 50 has only to decompress and provide any formatting, etc. to the image because the image has been generated using the server cluster 20 which will typically have substantially more processing power than the interface device 50.

Alternatively, if system 110 shown in FIG. 3A is being used, the server cluster 120 can generate three dimensional images and transmit these three dimensional images over the first network connection 140 directly to the display device 152 so that the display device 152 can display these images.

Referring again to FIG. 1, the server cluster 20 can be continuously generating three dimensional images and transmitting them to be displayed on the display device 52 as the virtual environment and the objects in the virtual environment change and alter. If a user changes the image being displayed by the interface device 50, such as by providing input to the interface device 50 using one of the input devices 54, the interface device 50 can receive the user input from the input device 54 and transmit the input data to the server cluster 20 over the second network 45. The server cluster 20 can then modify the three dimensional images being generated based on the input data and generate altered three dimensional images as a result of the user's input. These newly generated three dimensional images can then be transmitted to the interface device 50 over the high capacity first network 40 and the interface device 50 can display these new three dimensional image on the display device 52 connected to the interface device 50.

For example, if a user moves a cursor or avatar on the display device 52 using the input device 54 (such as a mouse), this input data is received by the interface device 50 where it is formatted and transmitted to the server cluster 20. The server cluster 20 then uses the received input data to make any changes to the image and, if necessary, begins generating altered three dimensional images based on the user's inputs, in this case a three dimensional image showing the cursor or avatar in a new position, and transmits this newly generated three dimensional image to the interface device 50 so that the interface device 50 can display these altered three dimensional images on the display device 52.

To allow a user to interact with the images on the display device 54, the transmission of input information, the generation of new three dimensional images altered in response to the input information by the server cluster 20 and the transmission of this newly generated three dimensional image back to the display device 54 must be done in substantially real-time. Additionally, to make the three dimensional images on the display device 52 appear fluid in their motion, the generated three dimensional images must be displayed on the display device 52 at a rate of 30 frames a second or more at a relatively evenly distributed rate.

In one aspect, the virtual environment could have the camera remain stationary while one or more objects are moving in relation to the camera. Alternatively, the camera and or background could be moving while objects in the environment either remain stationary or are moving.

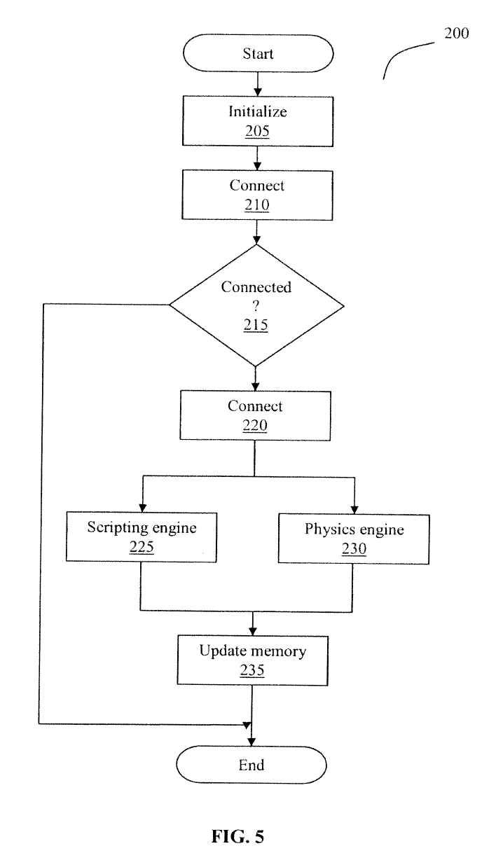

FIG. 5 illustrates a flowchart of a method 200 for a session between one of the interface devices 50 and the server cluster 20. The method 200 can include the steps of: initializing 205; connecting 210; checking that a connection has been made 215; connecting 220; starting the scripting engine 225; starting the physics engine 230; and updating the memory 235.

The method 200 can start with a user activating the interface device 50. This activation of the interface device 50 can be a user turning on the interface device 50, initiating a connection to the server cluster 20 using the interface device 50, etc. If system 110 shown in FIG. 3A is used, the method 200 starts when a user starts the interface device 150 and then switches the display device 152 to the channel transmitting the images generated by the server cluster 120.

At step 205 the session between the remote interface 50 and the server cluster 20 can be initialized and at step 210 a connection between the interface device 50 and the server cluster 20 can be established. The interface device 50 can transmit a connection request to the server cluster 20 using the second network connection 45. If a connection cannot be made at step 215, the session will end. In one aspect, if the server cluster 20 is configured as shown in FIG. 2, the head node 30 will receive the initialization request from the interface device 50 and will, in turn, establish connection states to each of the nodes 35 at step 220. If the nodes 35 each contain more than one processor 37, each node 35 can then establish a ready state with each of their processors 37.

At step 225 each node 35 can begin running the scripting engine and at step 230 each subnode 35 can begin running the physics engine.

At step 235 the method 200 can update the memory and updates the data describing the virtual three dimensional environment, which in turn will be used to generate three dimensional images illustrating the described three dimensional environment.

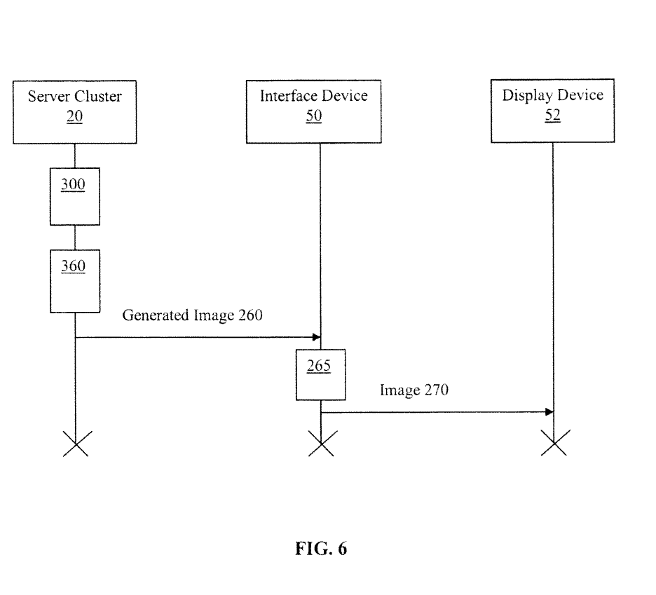

FIG. 6 is a sequence diagram showing a three dimensional image being generated by the server cluster 20 and the generated image being transmitted to the interface device 50.

The server cluster 20 generates a three dimensional image using a method 300 and a method 360 and then transmits this generated image 260 over the first network connection 40 to the interface device 50. When the interface device 50 receives the generated image 260 it will process the image 265 and transmit the image 270 to the display device 52 which will display the three dimensional image on its screen.

Alternatively, if system 110 shown in FIG. 3A is used, the server cluster 120 can transmit the generated images directly to the display device 152 for display.

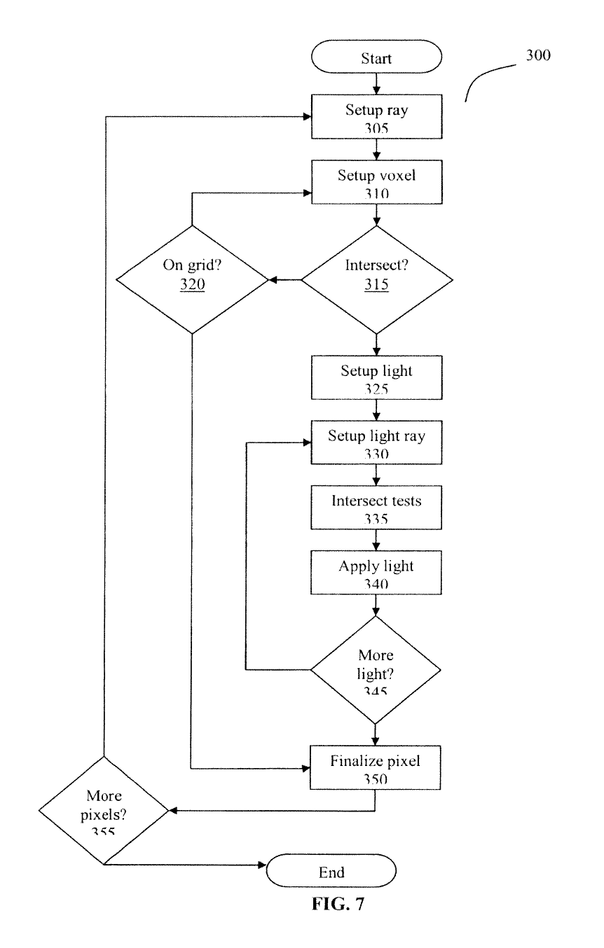

The image processing 265 performed by the interface device 50 will typically be formatting, setting resolution to match the display device, etc. To allow a user interactivity with the images displayed on the display device 52 requires the server cluster 20 to generate the three dimensional image in substantially real time. FIG. 7 is a flowchart showing the method 300 of the server cluster 20 generating a three dimensional image, in one aspect, to be transmitted to the interface device 50 and displayed on the display device 52. In one aspect, the three dimensional image can be rendered with a optimized ray tracer that uses a process of math equations applied towards triangles/physics/application data to form a photorealistic image.

Method 300 can include the steps of: setting up a ray 305; setting up a voxel 310; checking for an intersection 315; checking if a ray is still in the grid 320; setting up a light source 325; setting up a light ray 330; conducting intersection tests 335; applying light 340; applying more light 345; finalizing a pixel 350; and checking to determine whether more pixels need to be evaluated 355.

Method 300 starts when it is determined that there is new pixel data to process. At step 305 a new ray is generated. The ray will begin at an imaginary camera position and is directed towards the pixel that is being processed.

At step 310 voxels are set up. Starting at the imaginary camera location in three dimensional space, the ray traverses the voxels in the direction vector of the ray to the pixel that is being processed. Each voxel can contain a list of objects that exist in whole or in part within the discrete region of the three dimensional space represented by each voxel.

At step 315, method 300 determines if the generated ray intersects any objects with the space defined by the voxel that is being examined. If the ray does not intersect with an object in the voxel, then the method 300 moves on to step 320 and determines if the ray is still within a grid limit defined for the three dimensional image (i.e. inside the three dimensional environment being rendered in the three dimensional image). If the ray is still within the grid limits, the method 300, moves back to step 310 and sets up the next voxel along the line and repeats step 315 to see if the ray intersects any objects in the next voxel.

Because different sub-nodes 35 may be examining different voxels along a generated ray, simultaneously, the next selected voxel at step 310 may be the next voxel that has to be evaluated and may not necessarily be the next voxel along the generated ray. If at step 320 the ray is past the limits of the grid, this means that the ray has not intersected any objects and the method 300 moves to step 350 where the pixel is finalized based on no objects being present in the path of the generated ray.

When the method 300 reaches step 315 and the method 300 determines that the ray does intersect an object in the voxel being examined, the method 300 moves on to step 325 and the lighting effects are set up. The method 300 considers the available lights sources within an appropriate range of hit points and then sets the light value based on world data such as range, entropy, light specific properties (e.g. intensity and color), etc. At step 330 a light ray is generated originating from the light source and directed at the hit point (e.g. intersection of the generated ray and an objected within the grid limits) to determine the light contribution taking into account the lighting effects determined at step 325.

At step 335 the method 300 determines if intersections occur between the light source and hit point and at step 340 applies the light effect to the hit point, adjusted based on any intersections determined at step 335. For example, if the method 300 determines that the generated light ray intersects with a semi-transparent object before it contacts the hit point, the light contributed by the ray on the hit point might be reduced or changed at step 340 as a result, facilitating shadow effects. However, if the method 300 determines that the generated light ray intersects with an opaque object before contacting the hit point, the light contributed, determined at step 340, might be completely cancelled. Alternatively, if it is found that no objects intersect with the light ray at step 335 before reaching the hit point, substantially the full amount of light might be set at step 340.

Once the light is applied at step 340, the method 300 can then move on to step 345 and determine if there are any other light sources in the image. If more light sources are determined at step 345, then method 300 can return to step 330 and another light ray from the next light source are set up before steps 335 and 340 are performed using this new light source. However, if at step 345 there are no more light sources, the method 300 can move on to step 350 and finalize the pixel using the light contributions determined from all of the light sources. The finalizing of the pixel data can include gamma correcting the pixel and then moving the newly determined pixel data into memory. Additional effects such as radiosity, filters, etc. can also be applied at 350.

The method 300 can then move to step 355 and determine if there are any more pixels to evaluate to complete the three dimensional image. Because multiple subnodes 35 and processors 37 will typically be running methods 300 on various voxels and pixels, each processor 37 and subnode 35 will typically render only a portion of each three dimensional image. If more pixels remain to be rendered at step 355, the next ray can be step up and the method 300 performed for another pixel.

When there are no more pixels to determine at step 355, the method 300 can end.

In one aspect, to generate a composite three dimensional image, more than one virtual camera angle can be set and rays generated from the more than one camera angle. In this way, a composite image can be generated using more than one virtual camera position and generating rays from each of these different virtual camera angles.

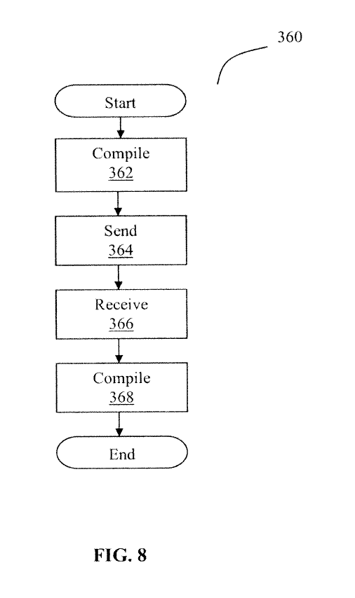

Once the subnodes 35 have performed method 300 and all of the pixels have been processed and stored back into memory, method 360 shown in FIG. 8 can be used to compile the three dimensional image and transmit the image to the interface device 50. Method 360 can include the steps of: compiling 362; sending 364; receiving 366 and compiling 368.

Method 360 can start and at step 362 each subnode 35 can compile the screen tiles generated by its processors 37 into three dimensional segments by compositing a left eye view with a right eye view. Each of these three dimensional segments can be sent to the head node 30 at step 364 where the head node 30 can receive them at step 366 and compile each of the received three dimensional segments into a single three dimensional image that can be compressed and encoded for transmission to the interface device 50 or display device 152 if system 110 is being used.

Referring again to FIG. 6, the server cluster 20 can transmit the generated three dimensional image 260 to the interface device 50 which will in turn display it on the display device 52.

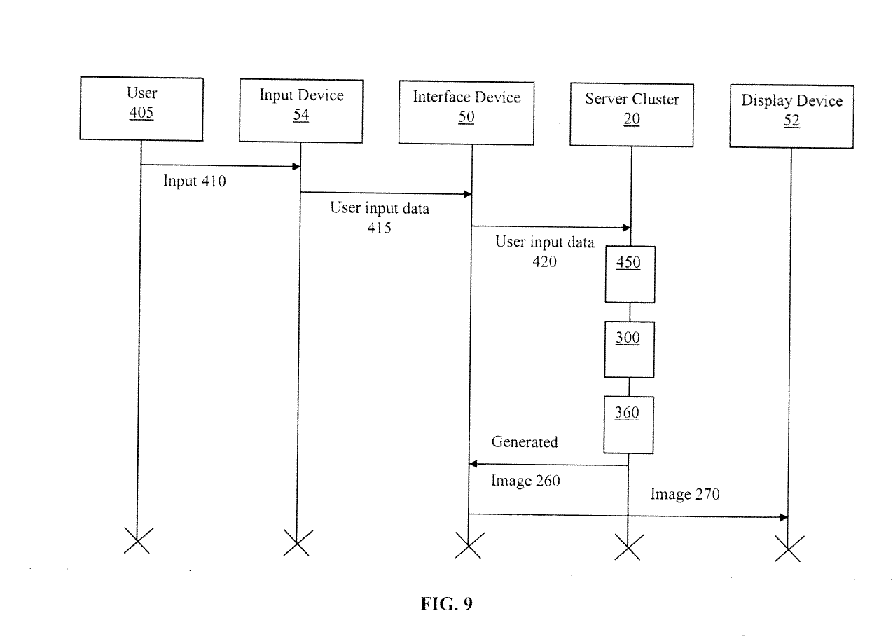

The server cluster 20 can continue to generate three dimensional images and transmit them to the interface device 50 to be displayed on the display device 52. However, if a user provides input through one of the input devices 54, to the interface device 50, in order to interact with the three dimensional image being displayed on the display device 52, the server cluster 20 has to alter the three dimensional images being generated using this user input. FIG. 9 illustrates a sequence diagram showing a user input entered by a user using an input device 54 being transmitted through the interface device 50 to the server cluster 20 and receiving a generated three dimensional image 260 altered in response to the user input.

When a user 405 uses the input device 54 to enter input 410, such as a mouse move, mouse click, move of a joystick, etc., the input device 54 translates the user input 410 into user input data 415 and transmits the user input data 415 to the interface device 50. The interface device 50 in turn can perform some data formatting on the user input data 415 and transmit it as user input 420 over the second network connection 45 to the server cluster 20. The interface device 50 can simply take the user input data 415 and perform mild formatting to allow it to be transmitted to the server cluster 20. However, in another aspect, the interface device 50 can process the incoming user input data 415, convert it to another form of data that is readable by the server cluster 20 and transmit this as the user input data 420 to the server cluster 20. In this manner, the interface device 50 can be configured to handle more processing of the user input data 415 (e.g. device drivers for in the input devices 54, converting the data received from the input device 54 to a uniform format, etc.), allowing the server cluster 20 to have a much reduced set of input data that it has to recognize and process.

When the server cluster 20 receives the user input data 420, the server cluster 20 can perform a method 450 to update the memory and alter the image being generated. Once the memory is updated, method 300 shown in FIG. 7 can be used to generate a new three dimensional image based on the memory that was updated in response to the user input and once method 300 has been performed and a new three dimensional image generated and compiled, the three dimensional image 260 can be transmitted by the server cluster 20 over the high capacity first network 40 to the interface device 50 (or directly to the display device 152 if system 110 is being used). With the image received by the interface device 50, the interface device 50 can perform mild formatting on the three dimensional image, such as decompressing the image, adjusting the resolution of the image and adjusting the size of the image, etc. and display the three dimensional image 270 on the display device 52.

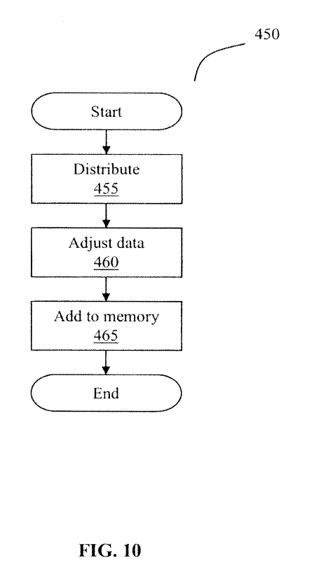

FIG. 10 is a flowchart of a method 450 that can be used to generate a three dimensional image that has been altered in response to the server cluster 20 receiving input data from a user. Method 450 can include the steps of: distributing data 455; adjusting the data 460; and adding to memory 465.

Method 450 begins when input data is received by the server cluster 20 from the interface device 50. When the server cluster 20 receives the input data, the input data will be received by the head node 30. At step 455 the input data is arranged for distribution to the subnodes 35 in the server cluster 20.

At step 460, the head node 30 can adjust the input data for fast reception of the data by the subnodes 35, such as cleaning and formatting the data.

At step 465, the arranged and adjusted data can be added to the memory to be accessed by the various nodes. The data used to describe the virtual three dimensional image that is being modeled can be updated and/or altered based on the input data that is received.

With the memory updated at step 465, the subnodes 35 can access the data indicating the changes to be made in the environment being shown in the three dimensional images. These subnodes 35 can then perform method 300 shown in FIG. 7 to generate three dimensional images based on the user input and this new image can be compiled and transmitted back to the interface device 50 using method 360 shown in FIG. 8.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A system for generating three dimensional images, the system comprising:
a plurality of interface devices, each interface device having an input, the interface device operative to receive input data from a user;
a display device associated with each interface device and operative to display three dimensional images;
at least one server operative to: for each display device, generate a series of three dimensional images and transmit the generated three dimensional images to the display device; and receive input data from each of the plurality of interface devices; and
at least one network connection operatively connecting the at least one server to each interface device and each display device,
wherein the at least one server, in response to receiving input data from one of the interface devices, is operative to alter the series of three dimensional images being generated by the at least one server for the display device associated with the interface device, based on the input data, and transmit the altered three dimensional images to the display device associated with the interface device.

2. The system of claim 1 wherein there is: a first network connection and a second network connection.

3. The system of claim 2 wherein the first network connection is a one-directional high capacity network connection for transferring three dimensional images between the server cluster and the plurality of interface devices.

4. The system of claim 3 wherein the second network connection is a bi-directional network connection having a lower capacity than the first network connection.

5. The system of claim 2 wherein the display devices are operatively connected to the at least one server by the first network and the plurality of interface devices are operatively connected to the at least one server by the second network.

6. The system claim 2 wherein the display devices and the plurality of interface devices are not directly connected to one another.

7. The system of claim 1 wherein there is a single network connection.

8. The system of claim 7 wherein the single network connection is a high-capacity bi-directional network connection.

9. The system of claim 1 wherein each display device is connected directly to the associated interface device and the at least one server transmits the generated three dimensional images to the interface device which then displays the three dimensional images on the display device.

10. The system of claim 1 wherein the server cluster broadcasts the same three dimensional images to each of the plurality of interface devices.

11. The system of claim 1 wherein the server cluster broadcasts different three dimensional images to each of the plurality of interface devices.

12. The system of claim 1 wherein a lenticular screen is provided over each display device.

13. The system of claim 1 wherein the at least one server comprises: a head node for receiving and transmitting information to the plurality of interface devices; and a plurality of sub-nodes that receive information from the head node, each sub-node having a plurality of processors.

14. A method for generating three dimensional images, the method comprising:
having at least one server generate a series of three dimensional images and transmit the series of three dimensional images to a display device; and
in response to the at least one server receiving input data from an interface device associated with the display device, altering the series of three dimensional images being generated and transmitting the altered three dimensional images to the display device.

15. The method of claim 14 wherein the three dimensional images are transmitted to the display device using a first network connection comprising a one-directional high capacity network connection for transferring three dimensional images between the server cluster and the plurality of interface devices.

16. The method of claim 15 wherein the input data is received from the interface device using a second network connection comprising a bi-directional network connection having a lower capacity than the first network connection.

17. The method of claim 14 wherein the display device and the associated interface device are not directly connected to one another.

18. The method of claim 14 wherein there is a single network operatively connected to a single network connection.

19. The method of claim 14 wherein the single network connection is a high-capacity bi-directional network connection.

20. The method of claim 14 wherein the display device is connected directly to the associated interface device and the at least one server transmits the generated three dimensional images to the interface device which then displays the three dimensional images on the display device.

21. The method of claim 14 wherein the at least one server comprises: a head node for receiving and transmitting information to the plurality of interface devices; and a plurality of sub-nodes that receive information from the head node, each sub-node having a plurality of processors.

22. A computer readable memory having recorded thereon statements and instructions for execution by a data processing system to carry out the method of claim 14.
